(19) United States
(12) Patent Application Publication
(10) Pub. No.: US 2023/0399999 A1
(43) Pub. Date: Dec. 14, 2023

(54) ROCKET ENGINE WITH POROUS STRUCTURE

(71) Applicant: Thomas NAGY-ZAMBO, Guelph (CA)

(72) Inventor: Thomas NAGY-ZAMBO, Guelph (CA)

(21) Appl. No.: 17/836,835

(22) Filed: Jun. 9, 2022

(51) Int. Cl. F02K 9/97; B33Y 80/00; B33Y 10/00; B22F 7/00; B22F 10/28; B22F 10/36

(52) U.S. Cl. CPC F02K 9/972; B33Y 80/00; B33Y 10/00; B22F 7/002; B22F 10/28; B22F 10/36; B33Y 70/00

(57) ABSTRACT

A rocket engine with porous structure is disclosed. The rocket engine can include an outer wall, a combustion chamber, a coolant distribution channel defined between the combustion chamber wall and the outer wall, and a manifold. The combustion chamber can have a combustion chamber wall, a first end, a second end opposite to the first end, and a nozzle section disposed at the second end. The manifold can be disposed at the first end of the combustion chamber and have an injector to direct a propellant into the combustion chamber and a coolant inlet to direct a coolant to flow through the coolant distribution channel. The combustion chamber wall can be manufactured through an additive manufacturing process and have a porous section to provide transpiration cooling to the combustion chamber from the coolant that flows through the coolant distribution channel.

### FIELD

The present disclosure generally relates to rocket engines and methods of manufacturing rocket engines. In particular, the present disclosure relates to rocket engines having a combustion chamber wall that includes a porous section having a porous structure for cooling.

### BACKGROUND

Rocket engines operate under extremely high temperature environments. The combustion reaction of propellants inside of a combustion chamber of a rocket engine may need to reach to a temperature exceeding the melting point of the combustion chamber materials in order to produce the required thrust force. Therefore, it is imperative to incorporate efficient cooling techniques with the design of rocket engines.

### BRIEF SUMMARY

Some embodiments described herein relate to a rocket engine that includes an outer wall, a combustion chamber, a coolant distribution channel defined between the combustion chamber wall and the outer wall, and a manifold. The combustion chamber can include a combustion chamber wall, a first end, a second end opposite to the first end, and a nozzle section disposed at the second end. The manifold can be disposed at the first end of the combustion chamber and can include an injector to direct a propellant into the combustion chamber and a coolant inlet to direct a coolant to flow through the coolant distribution channel. The combustion chamber wall can be manufactured through an additive manufacturing process and can include a porous section configured to provide transpiration cooling to the combustion chamber from the coolant that flows through the coolant distribution channel.

Some embodiments described herein relate to a combustion chamber for a rocket engine having a combustion chamber wall, a first end, a second end opposite the first end, and a nozzle section disposed at the second end. The combustion chamber wall can be manufactured through an additive manufacturing process and can include a porous section configured to provide transpiration cooling to the combustion chamber from a coolant that flows outside of combustion chamber wall.

In any of the various embodiments described herein, a cross sectional area of the second end can be smaller than a cross sectional area of the first end.

In any of the various embodiments described herein, the combustion chamber wall can be additively manufactured by selective laser sintering.

In any of the various embodiments described herein, the combustion chamber wall can be formed from a titanium alloy.

In any of the various embodiments described herein, the combustion chamber wall can be made of Ti-6Al-4V.

In any of the various embodiments described herein, the porous section of the combustion chamber wall can include pores having an average diameter in the range of 200 μm to 400 μm.

In any of the various embodiments described herein, the combustion chamber wall can have a thickness in a range of 0.5 mm to 10 mm.

Some embodiments described herein relate to a method of manufacturing a rocket engine having a combustion chamber having a porous section, the method including depositing a layer of metal powder, sintering the layer of metal powder by applying energy via an energy beam having a beam power and moving along a path at a beam speed in order to form a first sintered layer of a rocket engine based on a model of the rocket engine, depositing subsequent layers of the metal powder on the first sintered layer and sintering the subsequent layers to form additional sintered layers of the rocket engine based on the model, and adjusting one or more additive manufacturing parameters to form pores in the porous section of the combustion chamber.

In any of the various methods described herein, the metal powder can have an average diameter in a range of 20 μm to 80 μm.

In any of the various methods described herein, the pores can have an average diameter in the range of 200 μm to 400 μm.

In any of the various methods described herein, a volumetric energy density of the applied energy can be controlled to cause incomplete sintering of the metal powder, such that pores are created in the sintered layers.

In any of the various methods described herein, the volumetric energy density of the applied energy is controlled by controlling the beam power, and the beam power can be in a range of 120 W to 180 W.

In any of the various methods described herein, the volumetric energy density of the applied energy is controlled by controlling the beam speed of the energy beam, and the beam speed can be in a range of 2,400 mm/s to 2,800 mm/s.

In any of the various methods described herein, a hatch distance of the path can be in a range of 0.22 mm to 0.40 mm, such that the pores are created.

### BRIEF DESCRIPTION OF THE FIGURES

The accompanying drawings, which are incorporated herein and form part of the specification, illustrate embodiments and, together with the description, further serve to explain the principles of the embodiments and to enable a person skilled in the relevant art(s) to make and use the embodiments.

FIG. 1 is a longitudinal cross sectional view of a rocket engine according to an embodiment.

FIG. 2 is a sectional view of a rocket engine according to an embodiment.

FIG. 3 is a perspective view of a manifold of a rocket engine according to an embodiment.

FIG. 4 is a top view of a manifold of a rocket engine according to an embodiment.

FIG. 5 is a cross sectional view of the combustion chamber wall of FIG. 1 taken along line A-A in FIG. 1.

FIG. 6 is a diagram illustrating an additive manufacturing process for forming a combustion chamber wall having a porous section according to an embodiment.

FIG. 7 is a diagram of an energy beam hatch path in an additive manufacturing process according to an embodiment.

The features and advantages of the embodiments will become more apparent from the detail description set forth below when taken in conjunction with the drawings, in which like reference characters identify corresponding elements throughout. In the drawings like reference numbers generally indicate identical, functionally similar, and/or structurally similar elements.

### DETAILED DESCRIPTION OF THE INVENTION

Embodiments of the present disclosure are described in detail with reference to embodiments thereof as illustrated in the accompanying drawings. References to “one aspect,” “an aspect,” “an exemplary aspect,” etc., indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

The propulsion system of a rocket includes a rocket engine, which functions to provide thrust force for moving the rocket. In a combustion chamber of the rocket engine, propellants, such as a fuel and an oxidizer, react, combust, and explode into hot exhaust air. The hot exhaust air is accelerated as it exits the rear of the rocket engine through a nozzle section, thus producing the thrust force for moving the rocket forward.

During the combustion process of the propellants, the combustion of propellants can reach an extremely high temperature, for example approximately over 3000° C., which is above the melting point of most materials suitable for making a rocket engine and its combustion chamber. Accordingly, rockets are designed to incorporate a cooling technique to prevent the rocket engine from melting without compromising the combustion heat inside and thus the thrust force generated by the rocket engine.

To accommodate the high temperatures, various cooling techniques are known in rocket engine design, such as conductive cooling, radiative cooling, ablative cooling, regenerative cooling, and film cooling, among others. Conductive and radiative cooling are generally limited to combustion chamber materials that are capable of withstanding and transferring away high heat loads without reaching the material's melting point. Ablative cooling is designed to let at least a portion of the combustion chamber wall vaporize in order to take heat away. However, ablative suiting is generally not well suited for a structure that is intended to be reused. Regenerative cooling is a method of using propellants as a coolant before injecting them into the combustion chamber, but may be limited by the heat transfer efficiency of the propellants. In film cooling, inside of the combustion chamber, a coolant such as excess propellant that does not participate in the combustion process, is injected between the inner surface of the combustion chamber and the hot exhaust air, forming a thermal boundary to insulate the heat transfer to the combustion chamber wall. However, film cooling may not provide uniform cooling because it can be difficult to create a thermal boundary between the surface of the combustion chamber and the hot exhaust air that is uniform along the length of the combustion chamber. Further, film cooling may require a relatively large amount of coolant to provide adequate cooling performance. Accordingly, there is a need for alternate types of cooling methods that may provide uniform cooling that minimizes the amount of coolant.

The present invention relates to a rocket engine having a combustion chamber with a porous section to facilitate transpiration cooling of the rocket engine. The rocket engine includes fluid channels that direct coolant, such as a cooling fluid, along an exterior of the combustion chamber such that the coolant may flow through the porous section of the rocket engine to provide transpiration cooling of the combustion chamber. Transpiration cooling provides more uniform cooling than film cooling. Instead of injecting the coolant between the combustion chamber wall and the hot exhaust air inside of the combustion chamber, in the case of transpiration cooling, the coolant is injected over the exterior of the combustion chamber wall, e.g. the outer surface of the combustion chamber. As the combustion chamber wall has a porous section, the coolant can enter and exit the wall structure through the pores. The coolant can then uniformly distribute throughout the combustion chamber wall, thus functioning like a heat sink within the combustion chamber wall. As to the portion of the coolant that does not enter the wall structure, it can continue to absorb heat from the outer surface of the combustion chamber. The increased efficiency of transpiration cooling can reduce the amount of coolant used in the rocket engine, or alternatively, it allows the combustion chamber to operate under higher temperature and thus higher specific impulse (ISP) of the rocket engine.

The porous structure of the porous section is a key to effective transpiration cooling, however, it can be difficult to manufacture a porous structure by traditional manufacturing methods. The size and location of the pores need to be precisely controlled to provide the desired cooling performance as uniform distribution of pores within the combustion chamber wall may help to allow for a uniform distribution of the coolant. Further, the size of the pores should be selected to control the flow rate of the coolant for transpiration cooling but also to ensure that the structural stability of the combustion chamber wall is not compromised.

Therefore, one of the difficulties of implementing transpiration cooling in rocket engine design is that there lacks a controlled method to manufacture the porous structure that can balance the cooling performance and the structural stability. Traditional manufacturing processes, such as molding, extruding, and milling, may not be well suited for forming a porous structure, particularly with micron-sized pores and a large number of pores. Such processes may require individual drilling of pores, making such processes time-consuming, cumbersome, and expensive. Billets of a porous material, such as Porcerax may be machined into a desired shape, however, such processes are also time-consuming, expensive, and do not allow for precise control of the arrangement of pores. Further, manufacturing a porous structure by traditional methods may require assembly of multiple components which can further increase the time, labor and expense of forming the rocket engine, and can compromise the structural integrity of the rocket.

The present disclosure provides a method of additively manufacturing a rocket engine with a combustion chamber wall having a porous portion with a porous structure, thus resolving the manufacturing barrier to implementing transpiration cooling in the rocket engine design. Additive manufacturing processes can provide a controlled method for manufacturing porous structures with higher efficiency. Additive manufacturing also allows for precise control of the location and size of the pores. Further, additive manufacturing processes can manufacture porous structures and solid structures in a single process by adjusting parameters of the process. This is a more efficient way of manufacturing the entire rocket engine in a single process without the need to assemble multiple components or switching tooling. The inventors of the present application found that parameters of additive manufacturing processes can be controlled to achieve the desired porous structure that balances cooling performance and the structural stability. In some aspects, the energy density can be controlled to produce the combustion chamber wall having a porous section with a porous structure. In some aspects, the energy output from the energy beam using in additive manufacturing can be controlled to produce the porous structure. In some aspects, the speed that the energy beam travels can be controlled to produce the porous structure. And in some aspects, the path of the energy beam can be controlled to produce the porous structure. These parameters can be adjusted during manufacturing without bringing the entire process to a stop, which provides the flexibility of constructing porous structures at desired locations of the rocket engine.

Embodiments of the present disclosure will now be described in more detail with reference to the figures.

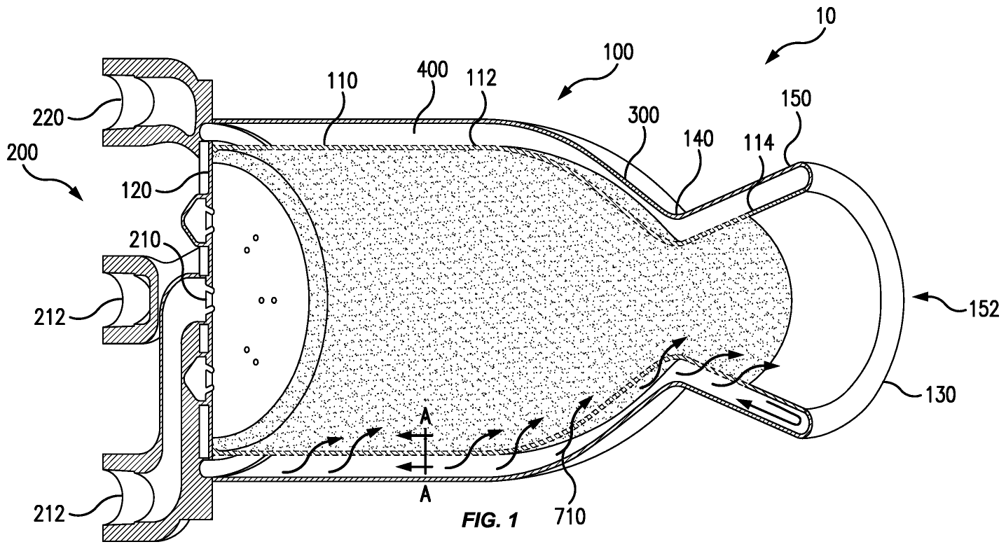

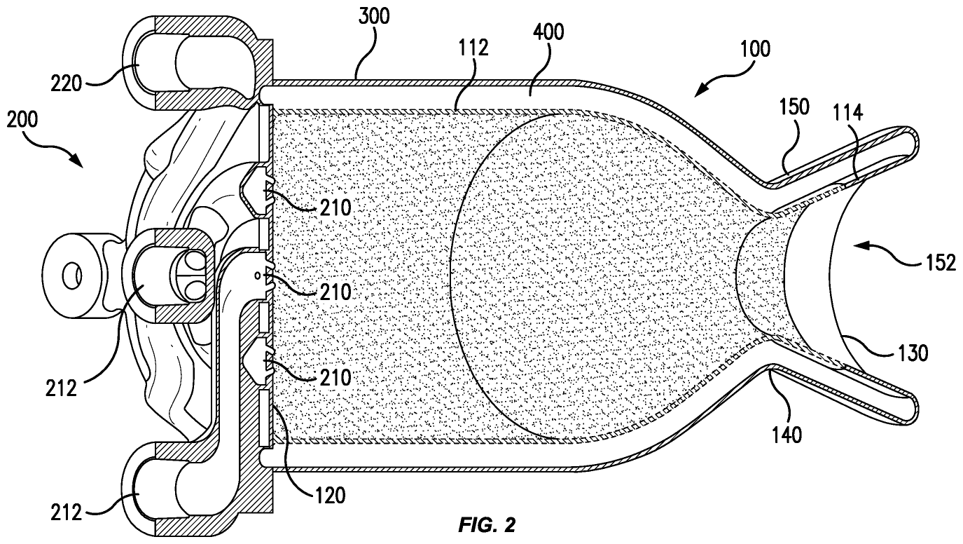

With reference to FIGS. 1 and 2, a rocket engine 10 is provided in side sectional views. Rocket engine 10 can include a combustion chamber 100 and a manifold 200. Combustion chamber 100 can include a first end 120 and a second end 130 opposite to first end 130. Manifold 200 can be arranged at first end 120 of combustion chamber 100. Manifold 200 may include one or more injectors 210 each having an inlet 212 for providing propellants to the combustion chamber. Manifold 200 may further define coolant inlets 220. A nozzle section 150 can be disposed at second end 130 with an opening 152. Combustion chamber 100 can also have a throat 140, which is a point with the smallest cross sectional area along combustion chamber 100. Throat 140 can be located closer to second end 130 than to first end 120, and nozzle section 150 can have a diverging shape from throat 140 to opening 152.

Combustion chamber 100 may have a tubular construction. In some embodiments, first end 120 may have a first diameter, and second end 130 may have a second diameter that is smaller than the first diameter. Combustion chamber 100 may taper from first end 120 toward second end 130, and particularly to throat 140, wherein throat 140 has the smallest diameter. Combustion chamber 100 may expand outwardly from throat 140 to second end 130 to form nozzle section 150. In some embodiments, combustion chamber 100 may have a generally circular, elliptical, or oval transverse cross sectional area. First end 120 of combustion chamber 100 may be substantially closed, and second end 130 may be substantially open for exhausting gas from combustion chamber 100.

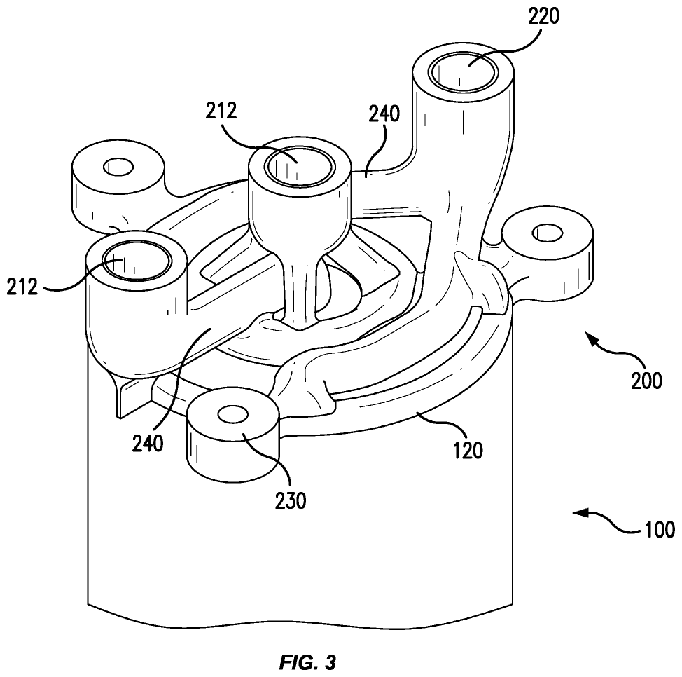

Combustion chamber 100 includes a combustion chamber wall 110. Combustion chamber wall 110 can have a thickness t1 (see FIG. 3) in a range of 0.5 mm to 10 mm. Combustion chamber wall 110 includes a porous section 112 to facilitate cooling of combustion chamber 100. In some embodiments, the entirety of combustion chamber wall 110 can be porous, such that porous section 112 extends the entire (e.g. 100%) longitudinal length of combustion chamber wall 110. In some embodiments, a portion of combustion chamber wall 110 can include porous section 112, while another portion of combustion chamber wall 110 is a solid, non-porous section 114. For example, in some embodiments, at least 5% of combustion chamber wall 110 is made of porous section 112, at least 15% of combustion chamber wall 110 is made of porous section 112, at least 30% of combustion chamber wall 110 is made of porous section 112, at least 50% of combustion chamber wall 110 is made of porous section 112, at least 70% of combustion chamber wall 110 is made of porous section 112, or at least 90% of combustion chamber wall 110 is made of porous section 112, with the remaining parts being made of solid, non-porous section 114. In some embodiment, combustion chamber wall 110 at throat 140 can be made of porous section 112, with the remaining part being made of solid, non-porous section 114. Further, thickness t1 of combustion chamber wall 110 of porous section 112 can be varied to allow varying pressure drop between an interior side 160 and exterior side 170 of combustion chamber wall 110.

In some embodiments, at a location along the longitudinal length of combustion chamber wall 110, porous section 112 can extend the entire (e.g. 100%) circumference of combustion chamber wall 110. In some embodiments, at a location along the longitudinal length of combustion chamber wall 110, porous section 112 can extend only a portion of the circumference of combustion chamber wall 110 with the remaining part being made of solid, non-porous section 114.

In some embodiments, combustion chamber wall 110 can have more than one porous section 112, and porous sections 112 can be spaced apart by solid, non-porous sections 114. In some embodiments, porous sections 112 can be spaced apart along the longitudinal length of combustion chamber wall 110, and in some embodiments, porous sections 112 can be spaced apart along the circumference of combustion chamber wall 110. In some embodiments, porous sections 112 and solid, non-porous sections 114 can be arranged in a pattern to optimize transpiration cooling effect. Combustion chamber wall 110 may include a regular and repeating arrangement of porous and non-porous sections 112, 114. Alternatively, porous sections 112 may be spaced from one another by non-porous sections 114. Porous sections 112 may be located and arranged based on the temperature profile of the combustion chamber so as to provide cooling in precise locations.

Porous section 112 can have a porosity defined by the density of the pores (e.g. the amount of pores within a unit area) and the average size of the pores. Porous sections 112 have higher porosity with higher density of the pores or larger average size of the pores and lower porosity with lower density of the pores or smaller average size of the pores. In some embodiments, porous sections 112 can have the same porosity. In some embodiments, porous sections 112 may differ in porosity. For example, a first porous section 112 at throat 140 may have a higher porosity than a porous section 112 at second end 130 of combustion chamber 100.

As described later, the porous structure of porous section 112 can help facilitate transpiration cooling of combustion chamber 100, which allows for better cooling efficiency compared to the solid structure. Accordingly, the amount, location, and porosity of porous section 112 can be determined by a heat map of combustion chamber 100 under operation. For example, the locations that withstand higher heat load can be made with porous section 112, and the locations that withstand lower heat load can be made with porous section 112 with lower porosity or with solid, non-porous section 114. In some embodiments, throat 140 may be required to withstand the highest heat load under operation, so a porous section 112 can be arranged at throat 140 of combustion chamber wall 110. In such embodiments, a remainder of combustion chamber wall 110 may include solid, non-porous section 114.

Outside of combustion chamber 100, rocket engine 10 can further include an outer wall 300. Outer wall 300 can surround and at least partially enclose combustion chamber 100. Outer wall 300 can be spaced from combustion chamber wall 110, such that a space is defined between outer wall 300 and combustion chamber wall 110. Such space can define a coolant distribution channel 400, allowing a coolant to flow to provide cooling to combustion chamber 100. Outer wall 300 can have a shape that conforms to the shape of combustion chamber wall 110, such that outer wall 300 is substantially parallel to combustion chamber wall 110, resulting in a substantially uniform cross sectional area of coolant distribution channel 400. In some embodiments, coolant distribution channel 400 can extend from first end 120 toward second end 130. In some embodiments, coolant distribution channel 400 can extend from first end 120 to a point between first end 120 and second end 130. For example, coolant distribution channel 400 can extend only the length of porous section 112 of combustion chamber wall 110. The length and location of coolant distribution channel 400 can be determined based on the heat map of combustion chamber 100 under operation.

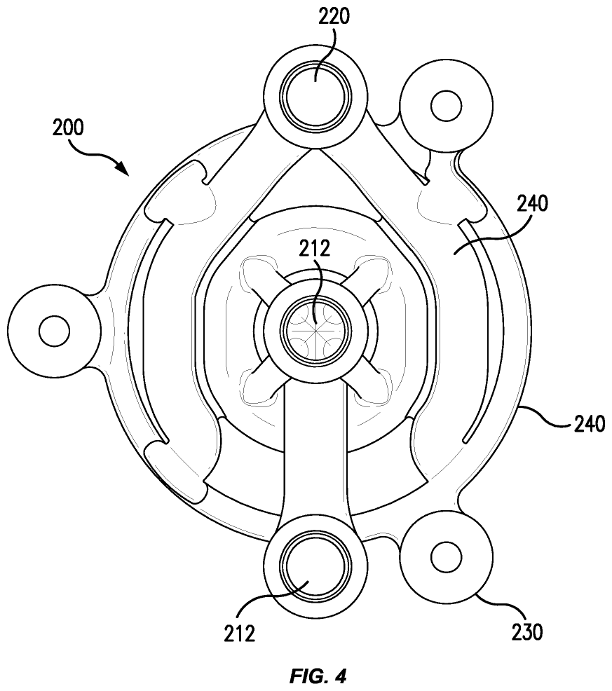

With reference to FIGS. 3 and 4, manifold 200 can have one or more injectors 210 that are each connected to a respective injector inlet 212. Manifold 200 can also include channels 240 that connect injector inlets 212 and injectors 210. Injector inlets 212 can be disposed on a substantially center point of manifold 200 or along the circumference of manifold 200. Each injector inlet 212 is configured to be connected to a propellant source. The injector inlet 212 may be connected to a propellant source through a valve, and the valve can control the feed of a propellant into combustion chamber 100 via injectors 210. The propellant source may be pressurized, or alternatively, a pump can increase the pressure of the propellant before entering into combustion chamber 100 via injectors 210. In some embodiments, rocket engine 10 can be a monopropellant rocket engine such that only a single propellant is required. The single propellant can be nitrous oxide, hydrogen peroxide, hydrazine, or other suitable propellants. In some embodiments, rocket engine 10 can be a bipropellant rocket engine, such that the propellants comprise a fuel and an oxidizer, and accordingly the propellant source can be a fuel source and an oxidizer source. Examples of a fuel include ethanol, liquid hydrogen, and Rocket Propellant-1 (RP-1). Examples of an oxidizer include oxygen, hydrogen peroxide, and nitrous oxide. A combination of a fuel and an oxidizer can be hypergolic, such that they ignite spontaneously upon contact.

Manifold 200 can include one or more coolant inlets 220. Coolant inlets 220 can be connected to coolant distribution channel 400 via channels 240. Coolant inlets 220 can be connected to coolant source through a valve, and the valve can control the feed of a coolant into coolant distribution channel 400. In some embodiments, such as regenerative cooling, the coolant can be the fuel itself, and coolant injectors 220 can be connected to the fuel source. When the coolant enters coolant distribution channel 400, it forms a coolant flow 710. Coolant flow 710 may fill up the entire length of coolant distribution channel 400. Accordingly, in some embodiments, a pump can be used to increase the pressure of the coolant.

After injectors 210 inject propellants into combustion chamber 100, the propellants (e.g. the fuel and the oxidizer) can combine and participate in a combustion reaction to generate heat and pressure. With the heat and pressure generated through the combustion reaction, propellants explode into hot exhaust air. Since propellants fed at injectors 210 are pressurized, either because of the pressurized propellant sources or because of a pump increasing pressure before injectors 210, the hot exhaust air will flow towards second end 130 of combustion chamber 100, which is lower in pressure compared to first end 120. As the hot exhaust air passes through throat 140, because of the decreased cross sectional area at throat 140, the velocity of the hot exhaust gas further increases, converting the thermal energy stored in the exhaust gas into kinetic energy. Therefore, thrust force is generated as the exhaust gas exits the rear of the rocket engine through nozzle section 150 and opening 152.

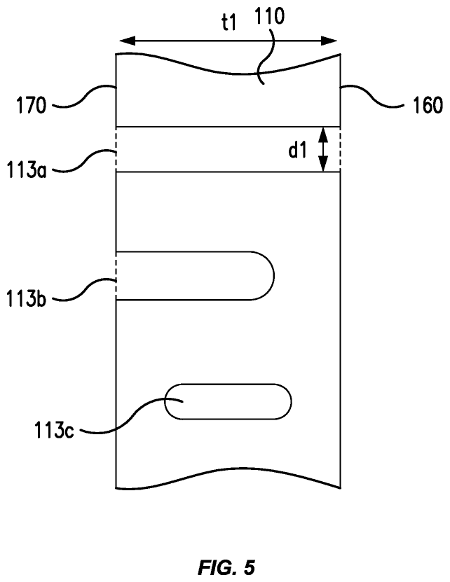

The combustion process increases the temperature within combustion chamber 100, coolant flow 710 and porous section 112 of combustion chamber wall 110 can provide transpiration cooling combustion chamber 100, preventing it from reaching a melting point and causing failure to rocket engine 10. Coolant distribution channel 400 directs coolant flow 710 along exterior side 170 of combustion chamber wall 110, such that coolant flow 710 may enter porous section 112 of combustion chamber wall 110 through pores 113 (FIG. 5). The porous structure of porous section 112 then allows coolant flow 710 to uniformly distribute within combustion chamber wall 110 to provide transpiration cooling. Once enough heat has been absorbed by coolant flow 710, then it can exit combustion chamber wall 110 through pores 113. In some embodiment, a portion of coolant flow 710 can enter combustion chamber 100 via pores 113 and flow along interior side 160 of combustion chamber wall 110, such that it can function as a thermal curtain between the hot exhaust gas and combustion chamber wall 110. In some embodiments, a portion of coolant flow 710 does not enter combustion chamber wall 110, and it can continue to absorb heat from exterior side 170 of combustion chamber 100.

The porosity of porous section 112 is selected to balance cooling performance and the mechanical integrity. With reference to FIG. 5, the size, the amount, and the location of pores 113 can determine the amount of coolant entering the structure and the flow rate of the coolant through the structure. While more pores with larger sizes increase the cooling performance, the structural stability and buildability of combustion chamber wall 110 may be reduced, which can cause fatal defect to rocket engine 10. Combustion chamber wall 110 can have a thickness t1 as measured from exterior side 170 to interior side 160 of combustion chamber wall 110 in a range of 0.5 mm to 10 mm, and pore 113a can extend through combustion chamber wall 110 with a maximum diameter d1 measured in a transverse direction of the pore. Pore 113a can allow coolant flow 710 enter the interior of combustion chamber 100. Combustion chamber wall 110 can also have pore 113b that extends from exterior side 170 of combustion chamber wall 110, to a midpoint within combustion chamber wall 110. Additionally, pore 113c can be constrained within combustion chamber wall 110, such that it is not connected with either exterior side 170 or interior side 160 of combustion chamber wall 110. All of pores 113 can have maximum diameter d1, or they can have different diameters that are within a range of 100 microns to 500 microns, 200 microns to 400 microns, or 250 microns to 350 microns.

In order to precisely control the porosity of porous section 112 used for transpiration cooling, combustion chamber 100 or rocket engine may be manufactured through additive manufacturing processes. In some embodiments, the additive manufacturing process may include powder beam fusion (PBF), selective laser melting (SLM), selective laser sintering (SLS), direct metal laser sintering (DMLS), laser powder bed fusion (LBF), or electron-beam melting (EBM), among other suitable additive manufacturing methods. Specifically, the inventors of the present application found that SLS and DMLS can be used to produce a porous structure. Unlike SLM or EBM, in a SLS or DMLS process, the metal or ceramic powder is sintered and not melted. Sintering uses less laser energy than melting, and it provides enough energy to weld the surfaces of the metal or ceramic powder together. Since the powders are not melted but welded together, pores can occur in between the powders. By controlling the parameters of the additive manufacturing process, the degree of sintering can be adjusted, and the desired porous structure for transpiration cooling can be obtained. In addition to the listed processes of additive manufacturing, it is appreciated that other additive manufacturing processes may also be suitable.

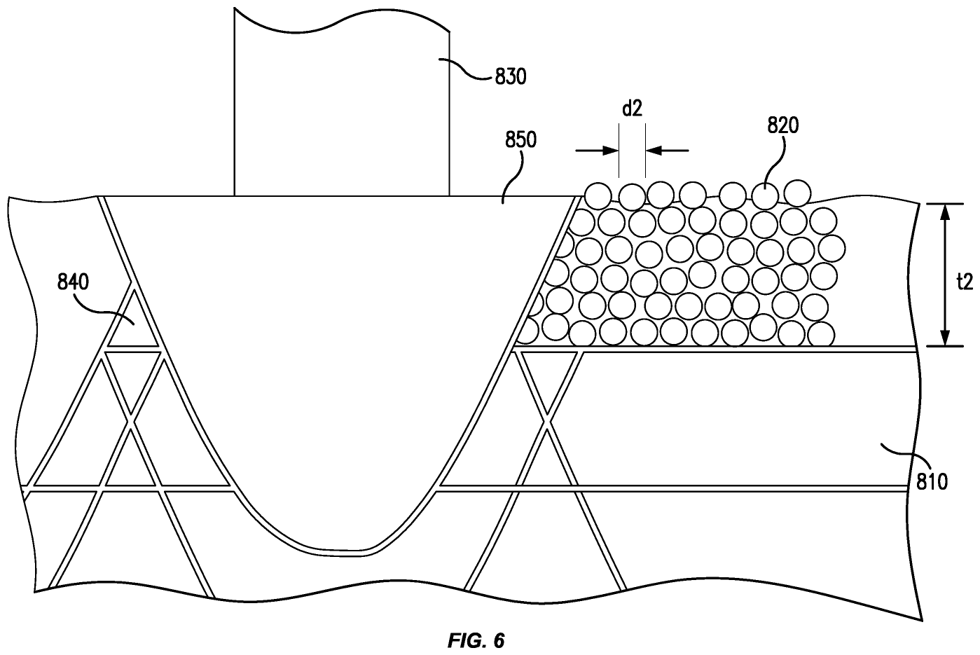

FIG. 6 is a schematic diagram of an additive manufacturing process. During the additive manufacturing process, a powder 820, such as a metal or ceramic powder is arranged in thin layers and are selectively sintered by laser energy. Each particle of metal powder 820 may have a maximum diameter d2. An average of diameter d2 of the particles of metal powders 820 may be in a range of 20 microns to 80 microns. Further, each layer deposited can have a thickness t2 in a range of 0.2 mm to 0.8 mm. In some embodiments, metal powders 820 can be made of titanium alloys, such as Ti-6Al-4V. In some embodiments, metal powders 820 can also be made of stainless steel, copper, and super alloys, such as Inconel. In some embodiments, ceramic materials may be used instead of or in addition to metal powders. An energy beam 830, such as a laser beam or electron beam, among others, may apply energy to heat and sinter the surfaces of metal powders 820 together. Sintered metal powders 820 become a sintered layer 810. The sintered layer 810 may be lowered to make room for a newly deposited layer of metal powders 820. This process of depositing and sintering layers of metal powder may be repeated in a layer by layer fashion in order to produce a rocket engine based on a model of the rocket engine, e.g. a CAD model of the rocket engine.

Pores may be formed in the additively manufactured structure by deliberate incomplete fusion of the metal powder. For each location of energy beam 830, there is a corresponding sintering pool 850, which represents the range of metal powders 820 being affected by the energy from energy beam 830. The shape and depth of sintering pool 850 can depend on the volumetric energy density from energy beam 830, and it is possible that at an intersection of adjacent sintering pools 850, some metal powders 820 do not receive sufficient energy to be fully sintered, such as location 840, which may form a pore after removing un-sintered metal powders 820. Accordingly, by adjusting the volumetric energy density from energy beam 830, the shape of sintering pool 850 can be controlled, and thus the size and amount of pores can be controlled. The lower the volumetric energy density, the smaller the shape of sintering pool 850, and thus the more porosity the structure. Volumetric energy density may be defined by Formula (I):

$$VolumetricEnergyDensity = \frac{BeamPower}{BeamSpeed * HatchDistance * LayerThickness}$$

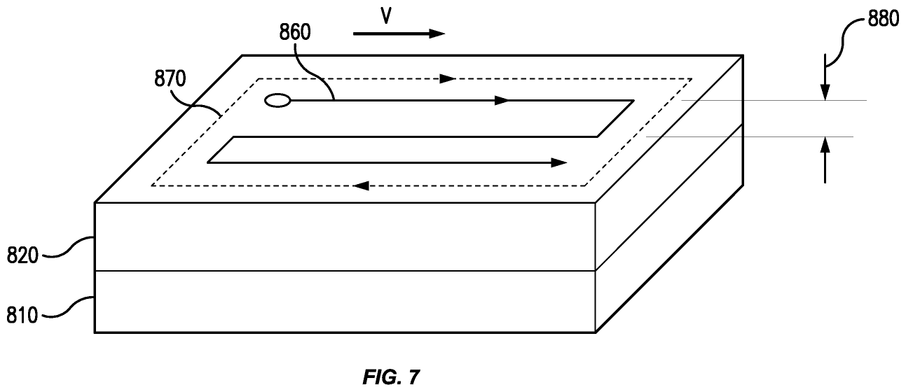

Additional variables are explained with reference to FIG. 7, which shows a path 860 of energy beam 830 during additive manufacturing. Energy beam 830 can travel back and forth along a path 860 with a beam speed v1 within a contour line 870. Metal powders 820 within contour line 870 can be sintered to form the desired structure, while metal powders 820 outside contour line 870 will not be sintered and can be removed. The distance between two adjacent hatch paths 860 is a hatch distance 880.

In some embodiments, while other variables in formula (I) remain unchanged, volumetric energy density may be lowered by lowering the beam power, by increasing the beam speed, or both. Beam power and the beam speed can be adjusted by a control input to energy beam 830 during a continuous process without bringing the process to a stop. Additively manufacturing processes may typically use a beam speed of about 1,300 mm/s, a beam power of 280 W, and a hatch distance of 0.12 mm to achieve full sintering, and thus solid, non-porous structure of a 0.06 mm layer of Ti-6Al-4V. However, to form pores, the beam power may remain at a baseline level of about 280 W, while increasing beam speed to about 2,200 to 3,000 mm/s, 2,400 to 2,800 mm/s, or 2,500 to 2,600 mm/s. Alternatively, the beam speed may remain at a baseline level of about 1,300 mm/s, while the beam power is decreased to about 100 to 180 W, 120 to 160 W, or 130 to 150 W. In some embodiments, to form pores, the beam power and the beam speed can be controlled relative to each other in order to produce a volumetric energy density at about 11 J/mm³ to 19 J/mm³, 13 J/mm³ to 16 J/mm³, or 14 J/mm³ to 15 J/mm³.

In some embodiments, while other variables in formula (I) remain unchanged, volumetric energy density may be increasing hatch distance 880. The larger hatch distance 880, the larger distance between sintering pools 850, and the more porosity the structure. Hatch distance 880 can be adjusted by a control input to hatch path 860, which can be similarly carried out during a continuous process without bringing the process to a stop. Typical hatch distance 880 for producing a solid structure of Ti-6Al-4V can be about 0.12 mm. Pores may form by increasing the hatch distance 880 to about 0.22 to 0.40 mm, 0.24 to 0.35 mm, or 0.25 to 0.30 mm.

In some embodiments, porous section 112 can be manufactured with the rest of the structure of rocket engine 10 in a single additive manufacturing process by adjusting one or more of the additive manufacturing parameters that affect volumetric energy density, such as beam power, beam speed, and hatch distance. For example, entire rocket engine 10 including manifold 200 and combustion chamber 100 can be manufactured through a single additive manufacturing process. The power from energy beam 830 can be increased when the sintered structure needs to be solid and non-porous and reduced when the sintered structure needs to be porous. Alternatively, beam speed can be decreased when the sintered structure needs to be solid and non-porous and increased when the sintered structure needs to be porous. Hatch distance 880 can similarly be decreased when the sintered structure needs to be solid and non-porous increased when the sintered structure needs to be porous. The adjustment of these parameters can be carried out without bringing the additive manufacturing process into a stop. The single process can improve efficiency because it eliminates the need of assembling parts together. The single process can also improve mechanical integrity of rocket engine 10.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A rocket engine comprising:
an outer wall;
a combustion chamber, comprising:
a combustion chamber wall,
a first end,
a second end opposite the first end
a nozzle section disposed at the second end, and
a throat defining the smallest cross sectional area along combustion chamber;
a coolant distribution channel defined between the combustion chamber wall and the outer wall; and
a manifold disposed at the first end comprising an injector to direct a propellant into the combustion chamber and a coolant inlet to direct a coolant to flow through the coolant distribution channel,
wherein the combustion chamber wall is manufactured through an additive manufacturing process, and
wherein the combustion chamber wall comprises a porous section arranged at the throat of the combustion chamber and non-porous sections arranged at a remainder of the combustion chamber wall,
wherein the porous section is integrally formed with the non-porous sections, and
wherein the porous section is configured to provide transpiration cooling to the combustion chamber from the coolant that flows through the coolant distribution channel.

2. The rocket engine of claim 1, wherein a cross sectional area of the second end is smaller than a cross sectional area of the first end.

3. The rocket engine of claim 1, wherein the combustion chamber wall is additively manufactured by selective laser sintering.

4. (canceled)

5. The rocket engine of claim 1, wherein the combustion chamber wall comprises a titanium alloy.

6. The rocket engine of claim 1, wherein the porous section comprises pores having an average diameter in the range of 200 μm to 400 μm.

7. A combustion chamber for a rocket engine, the combustion chamber comprising:
a combustion chamber wall;
a first end;
a second end opposite the first end; and
a nozzle section disposed at the second end,
wherein the combustion chamber wall comprises a plurality of porous sections that are separated by and integrally formed with non-porous sections, the plurality of porous sections are configured to provide transpiration cooling to the combustion chamber from a coolant that flows outside of the combustion chamber wall, and
wherein the combustion chamber wall is manufactured through an additive manufacturing process such that a first porous section of the plurality of porous sections has a first porosity and a second porous section of the plurality of porous sections has a second, different porosity.

8. The combustion chamber of claim 7, wherein the combustion chamber wall is additively manufactured by selective laser sintering.

9. The combustion chamber of claim 7, wherein the combustion chamber wall is made of Ti-6Al-4V.

10. The combustion chamber of claim 7, wherein the porous sections comprise pores having an average diameter in the range of 200 μm to 400 μm.

11. The combustion chamber of claim 7, wherein the combustion chamber wall has a thickness in a range of 0.5 mm to 10 mm.

12.-20. (canceled)

21. The rocket engine of claim 1, wherein the outer wall is substantially parallel to the combustion chamber wall.

22. The combustion chamber of claim 7, wherein the plurality of porous sections are spaced apart along a longitudinal length of the combustion chamber wall.

23. The combustion chamber of claim 7, wherein the plurality of porous sections are spaced apart along a circumference of the combustion chamber wall.

24. The combustion chamber of claim 7, wherein at least one of the plurality of porous sections is arranged at a throat of the combustion chamber.

25. The rocket engine of claim 1, wherein the combustion chamber wall is an integrally formed one-piece structure.

26. The rocket engine of claim 1, wherein the porous section comprises a pore extending from an exterior side of the combustion chamber wall to a midpoint within the combustion chamber wall.

27. The rocket engine of claim 1, wherein the porous section comprises a pore extending through an entire thickness of the combustion chamber wall.

28. The combustion chamber of claim 7, wherein the combustion chamber wall is an integrally formed one-piece structure.

29. The combustion chamber of claim 7, wherein at least one of the plurality of porous sections comprises a pore extending from an exterior side of the combustion chamber wall to a midpoint within the combustion chamber wall.

30. The combustion chamber of claim 7, wherein the first porous section is arranged at a throat of the combustion chamber, and the first porosity is higher than the second porosity.
